(19) United States
(12) Patent Application Publication
(10) Pub. No.: US 2020/0262460 A1
(43) Pub. Date: Aug. 20, 2020

(54) ROBOT OPERATING IN POWER-ASSIST MODE AND METHOD FOR MOVING THE SAME

(71) Applicant: LG ELECTRONICS INC., Seoul (KR)

(72) Inventors: Sunryang KIM, Seoul (KR); Jaecheon SA, Seoul (KR); Joohan KIM, Seoul (KR); Kangsoo SHIN, Seoul (KR)

(73) Assignee: LG ELECTRONICS INC., Seoul (KR)

(21) Appl. No.: 16/749,713

(22) Filed: Jan. 22, 2020

(30) Foreign Application Priority Data
Feb. 19, 2019 (KR) PCT/KR2019/001995
Nov. 27, 2019 (KR) 10-2019-0154443

(51) Int. Cl. B62B 5/00; G05D 1/00; G05D 1/02; B60W 30/09

(52) U.S. Cl. CPC B62B 5/0073; G05D 1/0016; G05D 1/0223; B60W 2720/24; G05D 2201/0216; B60W 2300/40; B60W 2720/10; B60W 30/09

(57) ABSTRACT

A robot includes a cart sized to receive one or more objects, a moving part coupled to the cart, a handle assembly coupled to the cart, a first sensor coupled to the handle assembly and being configured to sense force applied to the handle assembly, and one or more controllers. Such controllers are configured to: map a magnitude of the force sensed by the first sensor to a speed or to a direction of movement using a pattern of changes in the force that is sensed by the first sensor; and cause the moving part to move the cart according to the speed or to the direction of movement based upon changes in the force sensed by the first sensor.

### CROSS-REFERENCE TO RELATED APPLICATIONS

Pursuant to 35 U.S.C. § 119, this application claims the benefit of earlier filing date and right of priority to International Application No. PCT/KR2019/001995, filed on Feb. 19, 2019, and Korean Patent Application No. 10-2019-0154443, filed on Nov. 27, 2019, the contents of which are all hereby incorporated by reference herein in their entirety.

### BACKGROUND

### 1. Field of the Invention

The present disclosure relates to a robot that operates in power-assist mode and a method for moving the robot.

### 2. Description of Related Art

A large-scale retailer, a department store, an airport, a golf course, and the like, are places where exchange of goods and services takes place between people. People carry a variety of goods in the places. Accordingly, a device such as a cart that can help people to carry their goods may be useful in such places.

Conventionally, the user themselves moves the cart. There are times when the cart is heavy when full of goods. Thus, there is a growing need for a cart that may be connected to electric power and may move on the basis of control of the user. In the above-mentioned places where a large number of people visit and a variety of goods are moved, a cart that may not only move on the basis of control of the user but also autonomously. Accordingly, there is a need to develop a cart that may be easily moved by the user and may move according to the intention of the user while avoiding various obstacles. Presented herein is a method for moving a robot such as a cart autonomously and also under control of a user.

### SUMMARY

As an example, a technology is provided for which force applied to a robot by the user may be assisted by electric energy, thereby allowing the user to easily move the robot.

In this specification, a technology is provided for which the robot may move on the basis of changes in force such as magnitude of force, a difference in force, and the like, which is applied to a handle assembly by the user so that the user can control movements of the robot.

A technology is provided for which even when the same magnitude of force is applied, a speed or direction of movement of the robot may differ on the basis of differences in force applied to the robot by different users, obstacles near the robot, positions of the robot, and the like.

Other features that have not been mentioned may be understood from the following description and may be more clearly understood from the disclosed embodiments. Further, it will be understood that embodiments may be realized via various means and combination thereof that are described in the appended claims.

In an embodiment, a robot that operates in power-assist mode includes a force sensor that senses changes in force applied to a handle assembly of the robot, and a controller that controls a direction or speed of movement of a moving part on the basis of changes in the force sensed by the force sensor.

In an embodiment, the controller of the robot that operates in power-assist mode add maps magnitude of the force that is sensed by the force sensor as a speed or direction of movement of the robot using a pattern of changes in the force that is sensed by the force sensor of the robot.

In an embodiment, the controller of the robot that operates in power-assist mode and adjusts the speed of movement of the moving part, which is mapped in force that is sensed by a push sensor on the basis of the frequency with which a pull sensor senses force within a time period shorter than the shortest time period of movement of the robot after the push sensor senses force.

In an embodiment, the controller of the robot that operates in power-assist mode and calculates a difference between force sensed by a left force sensor and force sensed by a right force sensor and adjusts the direction of movement of the moving part of the robot toward a fixed obstacle in proportion to the calculated difference between the forces.

In an embodiment, a method for operating the robot that operates in power-assist mode includes sensing changes in force that is applied to the handle assembly of the robot by the force sensor of the robot, mapping magnitude of the force that is sensed by the force sensor as a speed or direction of movement of the robot using a pattern of changes in the force sensed by the force sensor by the controller, and moving in the mapped direction of movement of the robot or at the mapped speed of movement of the robot by the moving part of the robot.

In embodiments, force applied to a robot by the user may be assisted by electric energy, thereby allowing the user to easily move the robot.

In embodiments, the robot may move on the basis of changes in force such as magnitude of force, a difference in force, and the like, which is applied to a handle assembly by the user so that the user can control movements of the robot.

In embodiments, even when the same magnitude of force is applied, the speed or direction of movement of the robot may differ on the basis of differences in force applied to the robot by different users, obstacles near the robot, positions of the robot, and the like.

An embodiment includes a robot having a cart sized to receive one or more objects, a moving part coupled to the cart, a handle assembly coupled to the cart, a first sensor coupled to the handle assembly and being configured to sense force applied to the handle assembly, and one or more controllers. Such controllers are configured to: map a magnitude of the force sensed by the first sensor to a speed or to a direction of movement using a pattern of changes in the force that is sensed by the first sensor; and cause the moving part to move the cart according to the speed or to the direction of movement based upon changes in the force sensed by the first sensor.

Effects of the present disclosure are not limited to what has been described, and various effects may be readily drawn by one having ordinary skill in the art on the basis of configurations of the present disclosure.

### BRIEF DESCRIPTION OF THE DRAWINGS

FIG. 1 shows an appearance of a cart-robot according to an embodiment.

FIG. 2 shows a detailed configuration of a control module of a cart-robot according to an embodiment.

FIG. 3 shows a configuration of a force sensor according to an embodiment.

FIGS. 4A and 4B respectively show a perspective and side view of a detailed configuration of a force sensor according to an embodiment.

FIG. 5 shows a detailed configuration of a force sensor according to another embodiment.

FIG. 6 shows a configuration in which a button-type sensor according to an embodiment is used as a force sensor.

FIG. 7 shows a process during which a controller according to an embodiment controls a speed or direction of movement of a cart-robot in response to force that is sensed by a force sensor.

FIGS. 8A and 8B show configurations in which speed of movement of a cart-robot is variously mapped in response to a magnitude of force that is sensed by a force sensor according to an embodiment.

FIG. 9 shows a process of mapping a speed and direction of movement of a cart-robot using a pattern of changes in force that is sensed by a force sensor according to an embodiment.

FIGS. 10A and 10B show an example where a controller sets speed of movement of a cart-robot based on ranges of magnitude of force applied to the cart-robot by the user.

FIG. 11 is a block diagram of elements used by force sensor 210 for adjusting speed of a cart-robot according to an embodiment based on a change in force that is generated after the cart-robot is controlled.

FIGS. 12, 13A, 13B show components and a process of adjusting a direction of a cart-robot according to an embodiment based on a change in force that is generated after the cart-robot is controlled.

FIG. 14 shows a process of adjusting a speed or direction of movement of the cart-robot when an obstacle according to an embodiment is sensed.

FIG. 15 shows ranges and directions that are sensed by an obstacle sensor provided in a cart-robot according to an embodiment.

FIG. 16 shows a process during which a cart-robot according to an embodiment moves along a fixed obstacle.

FIG. 17 shows a process of identifying features of a user in an initial phase according to an embodiment.

FIG. 18 shows a process of identifying features of a user during movement according to an embodiment.

### DETAILED DESCRIPTION

Hereinafter, embodiments of the present disclosure will be described in detail with reference to the drawings so that those skilled in the art to which the present disclosure pertains can easily implement the present disclosure. The present disclosure may be implemented in many different manners and is not limited to the embodiments described herein.

In order to clearly illustrate the present disclosure, technical explanation that is not directly related to the present disclosure may be omitted, and same or similar components are denoted by a same reference numeral throughout the specification.

Further, some embodiments of the present disclosure will be described in detail with reference to the drawings. In adding reference numerals to components of each drawing, the same components may have the same reference numeral even if they are displayed on different drawings. Further, in describing the present disclosure, a detailed description of related known configurations and functions will be omitted when it is determined that it may obscure the gist of the present disclosure.

In describing components of the present disclosure, it is possible to use the terms such as first, second, A, B, (a), and (b), etc. These terms are only intended to distinguish a component from another component, and a nature, an order, a sequence, or the number of the corresponding components is not limited by that term. When a component is described as being “connected,” “coupled” or “connected” to another component, the component may be directly connected or able to be connected to the other component; however, it is also to be understood that an additional component may be “interposed” between the two components, or the two components may be “connected,” “coupled” or “connected” through an additional component.

Further, with respect to embodiments of the present disclosure, for convenience of explanation, the present disclosure may be described by subdividing an individual component, but the components of the present disclosure may be implemented within a device or a module, or a component of the present disclosure may be implemented by being divided into a plurality of devices or modules.

In this specification, devices like robot that are moved via the user's control and moved using electric power on the basis of the user's control may be referred to as such things as a smart cart, cart-robot or, for short, a cart. The embodiments of the present disclosure may be implemented on devices like robot. For convenience of explanation, the present disclosure may be described based on cart, and the described embodiments are embodiment of robot. Carts may be used in a large-scale retailer, a department store, and the like. Carts may also be used in an airport, a port, and the like that are visited by many passengers and tourists. Further, carts may be used in leisure spaces such as a golf course.

A cart-robot includes all sorts of devices that specifically analyze force applied to the cart-robot by the user and control speed of movement of a cart-robot, a direction of movement of a cart-robot or perform functions of operating/stopping a cart.

In this specification, a robot that takes a cart or that is integrated with a cart as an example is used for physical distribution or delivery. The robot includes all devices that are controlled by a user or that is semi-automatically moved while being piled with products. The robot that takes a cart as an example or the robot that comprises cart as an example also include a movable bed used in a hospital. Below, in this specification, a cart includes all robots that moves in proportion to magnitude of force of a user by assisting with the force of the user while the user pushes or pulls a certain portion of the robot.

Further, while the term “robot” is used in this disclosure, it will be understood by those of ordinary skill in the art that the disclosure is not limited to devices deemed solely with a robotic function or purpose, and that the embodiments of the present disclosure may be implemented with various other types of devices, terminals, and apparatuses, including various configurations and types of computers, electronic terminals, personal and home devices, appliances, and the like.

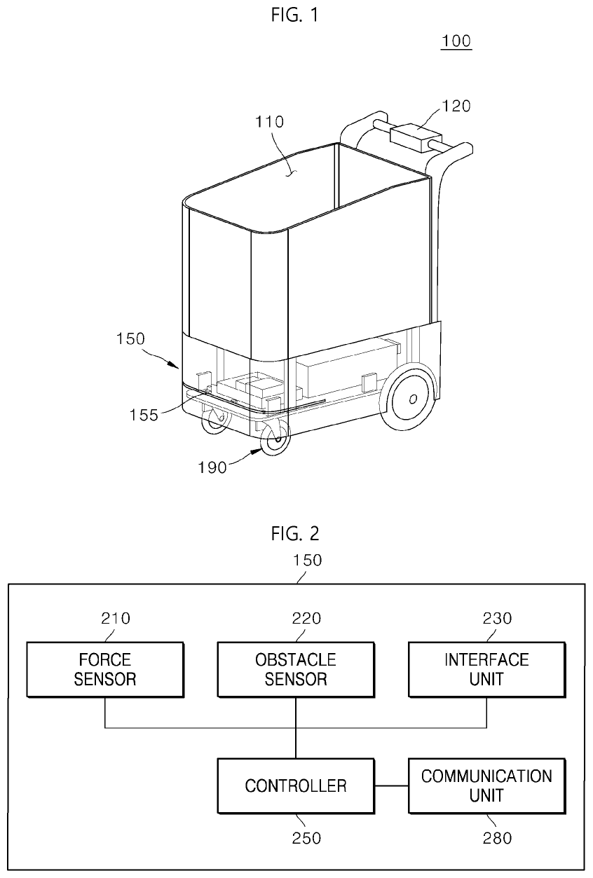

FIG. 1 shows an appearance of a cart-robot according to an embodiment, and FIG. 2 shows a detailed configuration of a control module 150 of a cart-robot according to an embodiment.

A cart-robot 100 includes a storage part 110, a handle assembly 120, a control module 150, and a moving part 190. The storage part 110 is space where objects are stored or loaded into by the user. The handle assembly 120 allows the user to control the movement of the cart-robot 100 manually or semi-automatically.

When the user applies force to control the cart-robot 100, the handle assembly 120 senses the force that is applied by the user. The control module 150 determines a direction, speed, and the like of movement of the cart-robot and moves the moving part 190, in response to the force that is sensed by the handle assembly 120. Accordingly, the user may push the cart-robot 100 forward and backward or change the direction of the cart-robot 100 using the handle assembly 120. The control module 150 controls the movement of the cart-robot 100.

When the user applies force to the handle assembly 120 to control the cart-robot, a force sensor 210 senses changes in the force that is applied to the handle assembly 120. The force sensor 210 can be provided in the handle assembly 120. The force sensor 210 can be placed near the handle assembly 120. A controller 250 of the control module 150 confirms the magnitude of force, direction of force and the speed at which force increases, and the like, which are sensed by the force sensor 210. That is, the force sensor 210 is physically in the handle assembly 120 and logically interacts with the controller 250 of the control module 150.

The handle assembly 120 may include an interface unit that outputs predetermined information to the user. The interface unit may also be controlled by the control module 150. The interface unit may show the user a method for controlling the cart-robot 100 and the handle assembly 120 or a warning message in the process of controlling the cart-robot 100 and the handle assembly 120.

An obstacle sensor that senses an obstacle near the cart-robot may be provided in a specific area of the cart-robot 100. The obstacle sensor 220 may be provided in various areas such as the upper end, the lower end, and the like of the cart-robot 100. For instance, a plurality of obstacle sensors 220 may be provided in an area designated as 155 to sense obstacles at locations such as the front, rear, left and right sides, and combinations therefore, of the cart.

In an embodiment, the obstacle sensor may be placed on the front surface/both lateral surfaces of the cart-robot in a direction where the cart-robot 100 moves. Additionally, the obstacle sensor may be provided on the front surface and the rear surface, on both lateral surfaces of the cart-robot in a direction where the cart-robot 100 moves backward.

The cart-robot 100 may be remotely placed, may confirm the position of a predetermined transmission module that is possessed by the user and may move while following the user. The cart-robot 100 may optionally perform the function of confirming a position of the user and following the user.

The moving part 190 moves the cart-robot based on control of the controller. Additionally, the moving part 190 may move the cart-robot along a predetermined path that is created by the controller 250. The controller 250 may confirm a state where the cart-robot 100 moves via movement of the moving part 190 on the basis of speed of rotation of wheels, the number of rotation of wheels, a direction of rotation of wheels, and the like. The moving part 190 may include a predetermined brake, and the controller 250 may control the brake of the moving part 190 to stop a moving cart-robot 100.

Additionally, the controller 250 may confirm horizontality of the wheels that constitute the moving part 190 and may confirm whether the cart-robot 100 is on a slope or on level ground. In another embodiment, the controller 250 may confirm whether the cart-robot is on a slope or on level ground, using a horizontality sensor.

The force sensor 210 can be placed in the handle assembly 120 or otherwise coupled to the handle assembly. When the user applies force to the handle assembly 120, the force sensor senses magnitude of the force, changes in the force, and the like. The force sensor 210 includes a variety of sensors such as a hall sensor, a magnetic sensor, a button-type sensor, and the like.

Though not illustrated in FIGS. 1 and 2, the cart-robot 100 may include a battery that supplies electric power to the moving part 190, the handle assembly 120 and the control module 150. The battery supplies the force that the moving part 190 moves the cart-robot via the control module 150.

The force that the user pushes the cart-robot is similar to the force that hardly moves the cart-robot in the absence of electric force or the force that moves the cart-robot at very slow speed. However, in embodiments, the controller 250 may map a speed or a direction of movement of the cart-robot with respect to the force that the user pushes the cart-robot, in power-assist mode. Accordingly, the user may move the cart-robot by applying a very small amount of force.

In table 1, below, if the user applies the same amount of force to the cart-robot, speed of movement of the cart-robot that is not supplied with electric energy is slower than that of the cart-robot in power-assist mode. That is, the cart-robot in power-assist mode is powered by electric energy, and the user may move the cart-robot faster by applying a small amount of force.

As an example, speed of movement of the cart-robot is doubled from 10 cm/sec to 20 cm/sec without electric energy when magnitude of the force applied to the cart-robot is doubled from 5 to 10. In power-assist mode, the controller may control mapping of the force applied to the cart-robot and speed of movement of the cart. Thus, when sensed force is 5, speed of movement of the cart-robot is mapped as 30 cm/sec while when sensed force is 10, speed of movement of the cart-robot is mapped as 50 cm/sec. Mapping may be adjusted in various ways in power-assist mode with respect to the force applied to the cart-robot, and a speed or direction of movement of the cart.

TABLE 1

| FORCE | SPEED OF MOVEMENT OF | SPEED OF MOVEMENT OF |
|---|---|---|
| APPLIED BY | CART-ROBOT WITHOUT | CART-ROBOT IN POWER- |
| USER | ELECTRICITY | ASSIST MODE |
| 5 | 10 cm/sec | 30 cm/sec |
| 10 | 20 cm/sec | 50 cm/sec |

Table 1 shows an increase in speed of movement of the cart-robot in power-assist mode, as but one example. The controller 250 may adjust force applied to the cart-robot and speed of movement of the cart-robot on the basis of whether an obstacle is near the cart-robot or whether properties of the space where the cart-robot moves (e.g., inclination of ground, a parking lot, and the like) such that the cart-robot moves slower or faster than the magnitude of the force applied to the cart.

In an embodiment, the controller 250 may adjust the magnitude of electric energy that is supplied to a motor for delivering power to the wheels of the moving part 190 or may adjust the number of rotations of the motor to adjust speed or direction of movement of the cart. The controller 250 may control power of both of the wheels or may adjust a direction of rotation of the wheels to control the direction of movement of the cart.

Various operations are discussed as being performed by components of cart-robot 100, however it will be understood that one or more or all of these operations may be performed by other aspects of cart-robot 100, such as the one or more controllers or processors. Further, it will be understood that one or more or all of these operations may be performed via other means, including other terminals or apparatuses configured to perform the operations which are in communication with cart-robot 100.

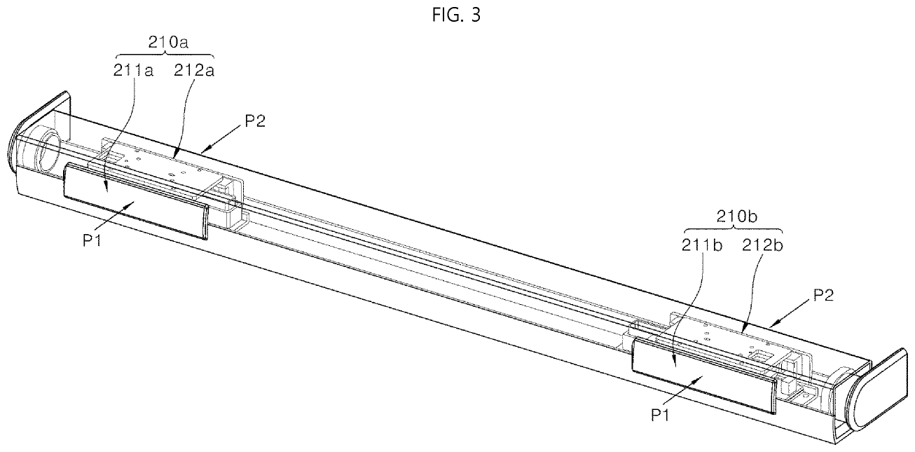

FIG. 3 shows a configuration of a force sensor according to an embodiment. In FIG. 3, the force sensor senses a pushing force or pulling force applied by the user and may be placed on either or both sides of the handle assembly 120.

Specifically, in FIG. 3, the force sensor 210a, 210b includes a push sensor 211a, 211b that senses a pushing force applied to the cart-robot by the user and a pull sensor 212a, 212b. The push sensor 211a, 211b is provided in an area that is reached by the user and senses the pushing force that is applied by the user in the direction of an arrow designated as P1. The pull sensor 212a, 212b is provided in an area that is reached by the user and senses the pulling force that is applied by the user in the direction of an arrow designated as P2.

The force sensor 210a, 210b senses force that is controlled by the user in a forward direction (P1) and a backward direction (P2). The controller 250 generates speed of movement of the cart-robot 100 based on the sensed force. Additionally, the controller 250 generates a direction of movement of the cart-robot 100, based on a difference in the forces that are applied to the force sensors 210a, 210b provided on the right and the left of the handle assembly.

Further, the controller 250 may customize a speed and direction of movement of the cart-robot 100 on the basis of changes in force that is applied to the force sensor 210a, 210b. That is, the controller 250 may adjust a direction or speed of movement of the moving part 190, based on changes in force that is sensed by the force sensor 210a, 210b. Furthermore, the controller 250 may control movement of the cart-robot on the basis of a pattern of changes in force that varies from person to person.

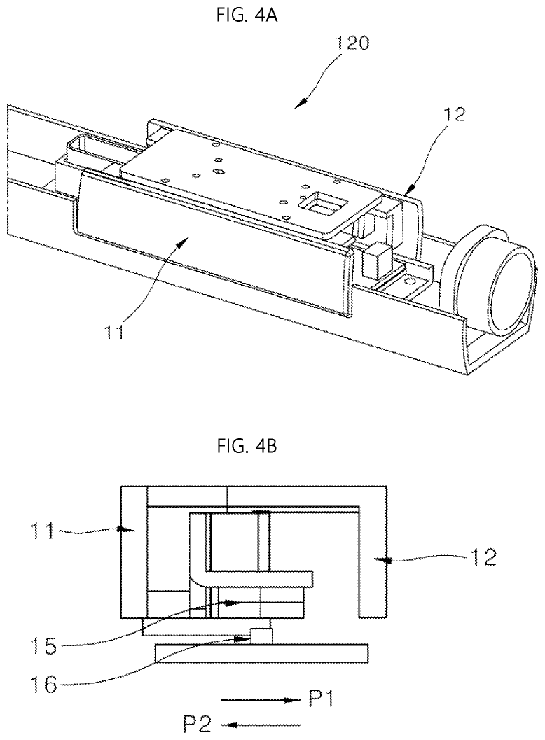

FIGS. 4A and 4B respectively show a perspective and side view of a detailed configuration of a force sensor according to an embodiment. In an embodiment, a push sensor and a pull sensor may be implemented with a pair of hall-magnetic sensors. A portion 11 to which force is applied when the user pushes the handle assembly 120 and a portion 12 to which force is applied when the user pulls the handle assembly 120 form part of the force sensor 210. Additionally, the force sensor 210 includes a magnet 5 that moves when force is applied to the portions 11, 12 and a hall sensor 16 that senses movement of the magnet 15. When the user pushes the cart-robot while applying force to the area 11, the magnet 15 moves in the direction of P1, and the hall sensor 16 senses changes in the magnetic field, which is caused by the movement, and senses that the force is applied in the direction of P1.

When the user pulls the cart-robot while applying force to the area 12, the magnet 15 moves in the direction of P2, and the hall sensor 16 senses changes in the magnetic field, which is caused by the movement, and senses that the force is applied in the direction of P2.

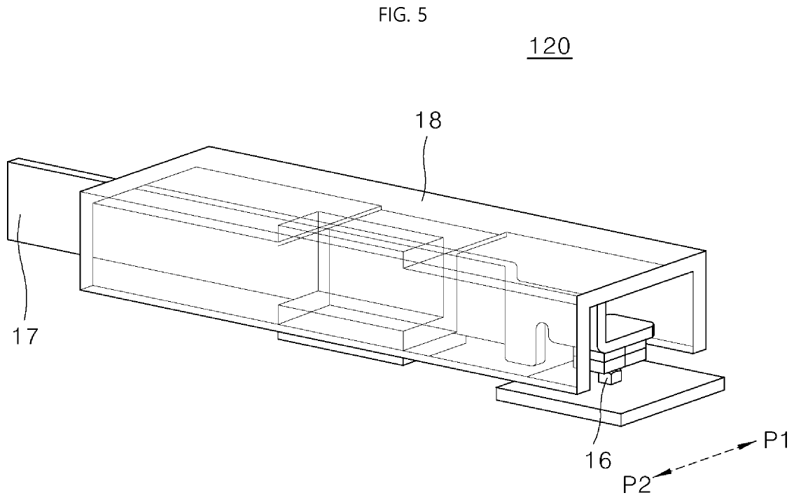

FIG. 5 shows a detailed configuration of a force sensor according to another embodiment. In FIG. 5, a leaf spring 17 that is placed in a bracket 120 in the handle assembly 120 is bent when the user applies force to the handle assembly 120 forward/backward. Thus, the magnet 15 at the end of the leaf spring 17 moves, and the hall sensor 16 may sense that force is applied in the direction of P1 or P2. A value that is sensed by the hall sensor 16 is provided to the controller 250, and the controller 250 may move the cart-robot 100 on the basis of the extent to which force is applied.

FIGS. 4A, 4B and 5 show a hall sensor as an example of the force sensor. However, the present disclosure is not restricted. In an embodiment, a load cell may be provided respectively in the push sensor 211a, 211b and the pull sensor 212a, 212b in FIG. 3 such that the controller 250 confirms a state where force is applied by means of changes in pressure.

When the load cell is applied, a metallic resistor that is deformed by pressure is disposed respectively in the push sensor 211a, 211b and the pull sensor 212a, 212b. When an external force is applied to the push sensor 211a, 211b and the pull sensor 212a, 212b, the push sensor 211a, 211b and the pull sensor 212a, 212b may sense changes in value of resistance caused by deformation of the metallic resistor and may provide the same to the controller 250.

In another embodiment, a resistive sensor may be disposed respectively in the push sensor 211a, 211b and the pull sensor 212a, 212b. The resistive sensor includes a pressure-sensitive material. When pressure is applied, density of the pressure-sensitive material increases. The resistive sensor senses force based on a value of resistance that is generated when the density of the pressure-sensitive material increases. Accordingly, when an external force is applied to the push sensor 211a, 211b and the pull sensor 212a, 212b, the push sensor 211a, 211b and the pull sensor 212a, 212b may sense changes in value of resistance that is caused by changes in density of the pressure-sensitive material and may provide the same to the controller 250.

In another embodiment, a capacitive sensor may be disposed respectively in the push sensor 211a, 211b and the pull sensor 212a, 212b. When pressure is applied to the capacitive sensor, there is a change in distances between electrodes in the capacitive sensor. The capacitive sensor may sense force on the basis of changes in a capacitor value, which are caused when there is a change in distances between electrodes in the sensor. Thus, the push sensor 211a, 211b and the pull sensor 212a, 212b may sense changes in a capacitor value, which are caused when an external force is applied, and may provide the same to the controller 250.

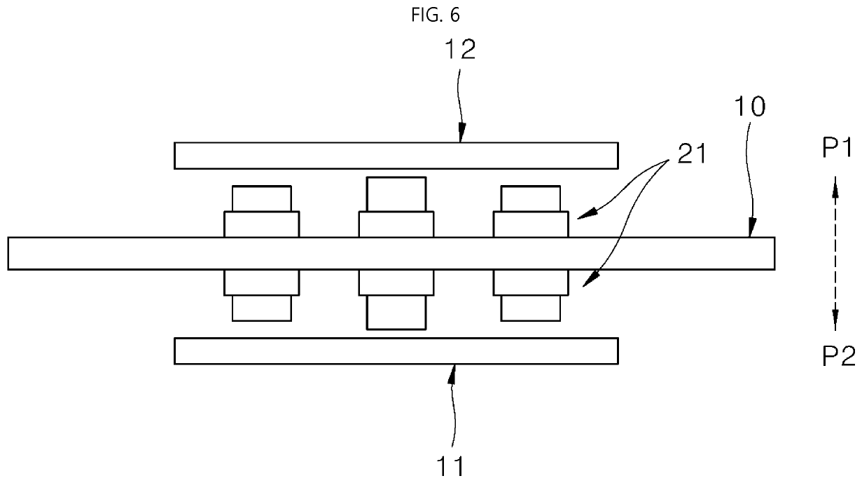

FIG. 6 shows a configuration in which a button-type sensor according to an embodiment is used as a force sensor. A plurality of button-type sensors 21 are coupled to a central supporter 10 in the handle assembly 120. The plurality of button-type sensors are shown having different heights.

When the user pushes the cart-robot while applying force to the area 11, each of the button-type sensors 21 is pressed or some of the button-type sensors are pressed. Accordingly, the force sensor may sense that force is applied in the direction of P1 on the basis of the scope of the pressed button-type sensors and height of the pressed button-type sensors.

When the user pulls the cart-robot while applying force to the area 12, each of the button-type sensors 21 is pressed or some of the button-type sensors are pressed. Accordingly, the force sensor senses that force is applied in the direction of P2 on the basis of the scope of the pressed button-type sensors and height of the pressed button-type sensors.

That is, when button-type sensors having different heights are used, the controller 250 may confirm the extent to which force is applied to the force sensor, on the basis of which buttons are pressed and on the basis of depth to which the buttons are pressed.

The various force sensors shown in FIGS. 3 to 6 sense magnitude of force that is measured when the user applies force. Additionally, each of the force sensors on the right and the left of the handle assembly may sense the magnitude of forces on the right and the left respectively when the user applies force such that the controller 250 sets a direction of movement of the cart.

Further, the controller 250 may adjust speed of movement of the cart-robot 100 in accordance with properties of the user on the basis of magnitude of force that is applied to the force sensor.

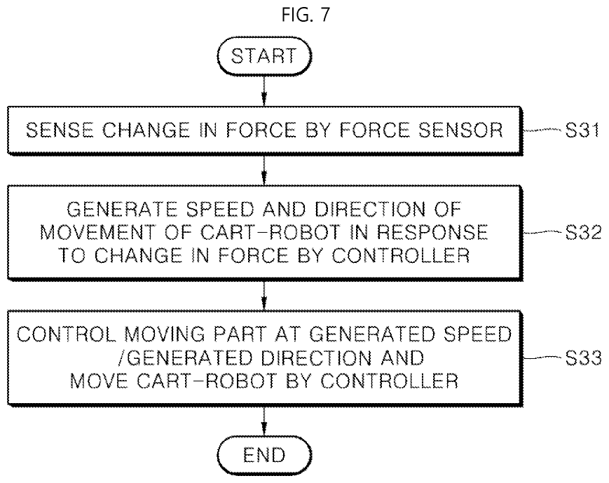

FIG. 7 shows a process during which a controller according to an embodiment controls a speed or direction of movement of a cart-robot in response to force that is sensed by a force sensor.

The force sensor 210 senses changes in force (S31). The controller 250 generates a speed and/or direction of movement of the cart-robot in response to changes in force that is sensed by the force sensor 210 (S32). Additionally, the controller 250 controls the moving part 190 at the generated speed/the generated direction and moves the cart-robot (S33).

The speed is proportional to the force that is sensed by the force sensor. If the force that is sensed by the force sensor is F1, the controller generates speed of movement of the cart-robot (Cart_V) in proportion to F1 as shown in equation 1.

Cart_V=F1*M1 Equation 1:

In Equation 1, M1 may vary from user to user, and M1 may be set as a default value at the cart-robot, for example, in the memory of controller 250. The speed of the power-assist mode at which the cart-robot actually moves is faster than that of the speed at which the user pushes the cart-robot using the same magnitude of force without electric power. That is, although the force that is applied to the cart-robot is not great enough to actually move the cart-robot, the cart-robot may move in the power-assist mode.

Additionally, the controller 250 may generate speed of movement of the cart-robot quantitatively proportional to the force that is sensed by the force sensor or may generate speed of movement of the cart-robot non-quantitatively proportional to the force that is sensed by the force sensor. For instance, M1 may be differently set depending on range of the force that is sensed by the force sensor.

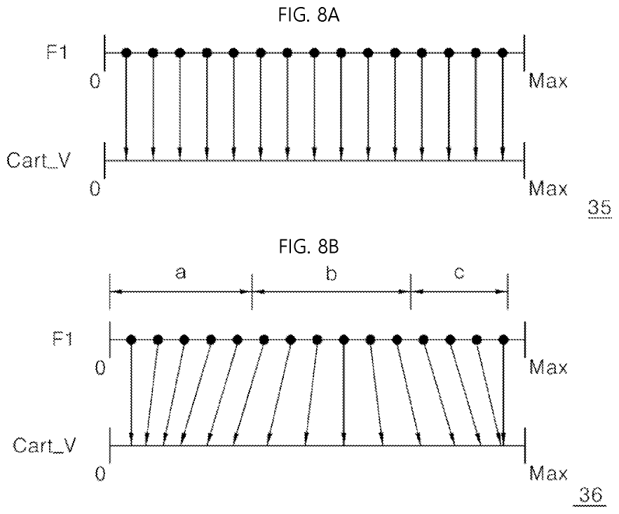

FIGS. 8A and 8B show configurations in which speed of movement of a cart-robot is variously mapped in response to a magnitude of force that is sensed by a force sensor according to an embodiment. In power-assist mode, the controller 250 may generate speed of movement of a cart-robot that is faster than the speed of movement of a cart-robot without electric power in response to the magnitude of force.

In FIG. 8A, reference numeral 35 shows mapped speed of movement of the cart-robot, which is constantly proportion to magnitude of the force that is sensed by the force sensor. The speed of movement of the cart-robot is mapped such that the speed of movement of the cart-robot increases by as much as an increase in the magnitude of the force that is sensed by the force sensor.

In FIG. 8B, reference numeral 36 shows mapped speed of movement of the cart-robot, which is differently proportional to magnitude of the force that is sensed by the force sensor in each sections of a, b, and c. When magnitude of the force that is sensed by the force sensor is in section a, the controller 250 increases the speed of movement of the cart-robot such that an increase in the speed of movement of the cart-robot is less than an increase in magnitude of the force that is sensed by the force sensor. That is, when force in section a is applied, the controller 250 maps speed of movement of the cart-robot such that the speed of movement of the cart-robot slowly increases. Refer to equation 2.

Cart_V=F1*Ma Equation 2:

In section a, an increase in the speed of movement of the cart-robot is smaller than an increase in the magnitude of the force that is sensed by the force sensor. The user may not know how much force is required to move the cart-robot when the user starts to move the cart. When the user starts to manipulate the cart-robot, an increase in the speed of movement of the cart-robot, which is smaller than an increase in the magnitude of the force that is applied to the cart-robot, brings the following advantages. If mapping in section a is applied to the cart-robot, the cart-robot is prevented from moving farther away than intended. If mapping in section a is applied to the cart-robot, the cart-robot is prevented from moving faster than intended. Additionally, when the user applies greater force in section a, the force sensor senses force in section b.

If magnitude of force that is sensed by the force sensor is in section b, the controller 250 increases speed of movement of the cart-robot such that an increase in the speed of movement of the cart-robot is greater than an increase in magnitude of force that is sensed by the force sensor. That is, when force in section b is applied, the controller 250 maps speed of movement of the cart-robot such that the speed of movement of the cart-robot rapidly increases. Refer to equation 3.

Cart_V=F1*Mb Equation 3:

If magnitude of force that is sensed by the force sensor is in section c, the controller 250 increases speed of movement of the cart-robot such that an increase in the speed of movement of the cart-robot is less than an increase in magnitude of force that is sensed by the force sensor. That is, when force in section c is applied, the controller 250 maps the speed of movement of the cart-robot such that the speed of movement of the cart-robot slowly increases. Refer to equation 4.

Cart_V=F1*Mc Equation 4:

In equations 2 to 4, Ma<Mb, Mc<Mb are satisfied.

When there is a big difference in the forces that are sensed by the right force sensor and the left force sensor, the controller 250 determines a direction of movement of the cart-robot, on the basis of the difference. For instance, “magnitude of the force that is sensed by the right force sensor—magnitude of the force that is sensed by the left force sensor” may be applied to reference numeral 35 or 36 in FIGS. 8A, 8B. For example, the difference of the magnitude of the force that is sensed by the right force sensor and the—magnitude of the force that is sensed by the left force sensor is applied to reference numeral 35 or 36 in FIGS. 8A, 8B. The controller 250 may set direction angles (angle to the right or to the left) based on the difference in the forces that are sensed by both of the force sensors.

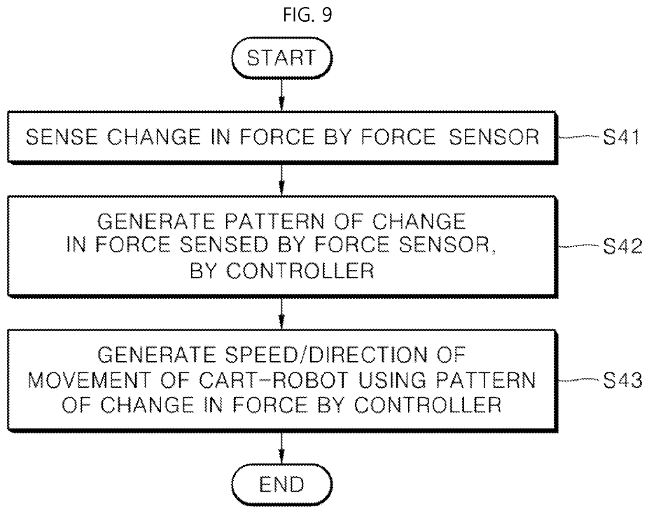

FIG. 9 shows a process of mapping a speed and direction of movement of a cart-robot using a pattern of changes in force that is sensed by a force sensor according to an embodiment.

The force sensor senses changes in force (S41). The controller 250 generates a pattern of changes in the force that is sensed by the force sensor (S42) and generates a speed/direction of movement of the cart-robot using the pattern of changes in the force (S43).

That is, the controller 250 generates a speed and direction of movement of the cart-robot on the basis of a pattern of force applied by each user because the pattern of applied force varies from user to user. For instance, a user who is strong may apply a great amount of force to the force sensor 210. In this case, if speed of movement of the cart-robot is mapped as it is, the speed of movement of the cart-robot may increase rapidly.

On the contrary, a user who is weak may apply a small amount of force to the force sensor 210. In this case, if speed of movement of the cart-robot is mapped as it is, the speed of movement of the cart-robot may be slow.

Accordingly, the controller 250 may map the magnitude of the force that is sensed by the force sensor 210 on the basis of a pattern of changes in the force that is sensed by the force sensor 210 as a speed or direction of movement of the cart-robot so as to customize the speed of movement of the cart.

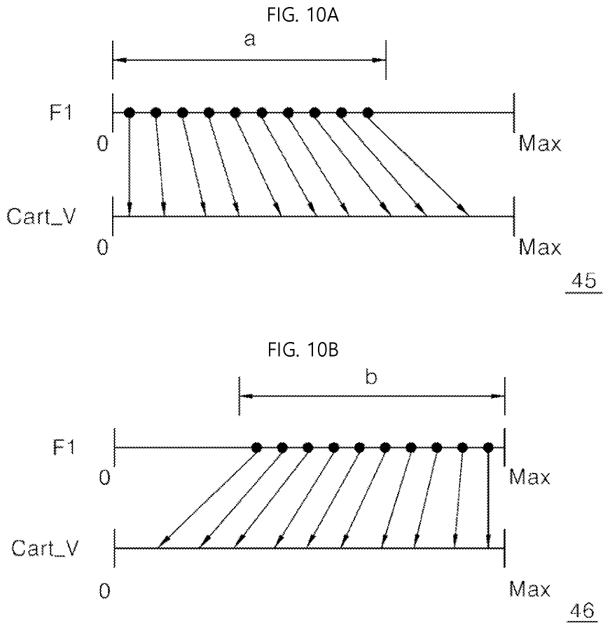

FIGS. 10A and 10B show an example where a controller sets speed of movement of a cart-robot based on ranges of magnitude of force applied to the cart-robot by the user. FIG. 10A shows reference numeral 45, where a range of magnitude of force applied to the force sensor 210 by the user is section a. Accordingly, the controller 250 sets speed of movement of the cart-robot such that an increase in the speed of movement of the cart-robot is greater than an increase in magnitude of force because the user is weak. FIG. 10B shows reference numeral 46, wherein a range of magnitude of force applied to the force sensor 210 by the user is section b. Accordingly, the controller 250 sets speed of movement of the cart-robot such that an increase in the speed of movement of the cart-robot is less than an increase in magnitude of force because the user is strong.

Information on whether the user is weak or strong may be transmitted to the cart-robot from the outside. In an embodiment, information on the user who uses the cart-robot may be input to the cart. For instance, when the user transmits user information to the cart-robot 100 using a smart phone to use the cart-robot, a communication unit 280 of the cart-robot may adjust speed of movement of the cart-robot based on the received user information. The user information may include information on the age, the muscular strength and the physical characteristics of the user. When user information that is stored in a smart phone is tagged onto the cart-robot, the communication unit 280 of the cart-robot receives the user information.

Additionally, an interface unit 230 of the cart-robot outputs a message for confirming the age group or gender of the user when the user selects a cart-robot and starts to move the cart. The user inputs its age and gender. The input information may be used by the controller 250 of the cart-robot to adjust sections of ranges of speeds of movement of the cart-robot and magnitude of forces, such as that shown in FIGS. 10A, 10B.

Further, the cart-robot may sense weight of loaded objects. When sensing that loaded objects are heavy, the cart-robot may set speed of movement of the cart-robot on the basis of section a. On the contrary, when sensing that loaded objects are light, the cart-robot may set speed of movement of the cart-robot on the basis of section b. The controller 250 may adjust speed of movement of the cart-robot for user safety when loaded objects are heavy or, as weight becomes heavy in the aspect of user interface, may decrease the speed of movement of the cart-robot, which is mapped in sensed force of the cart-robot, such that the user may sense an increase in weight of loaded objects.

The mapping of FIGS. 10A, 10B may be applied to a difference in forces that are sensed by both of the force sensors when a direction of movement of the cart-robot is set.

A pattern of changes in force may be generated on the basis of a certain time period depending on changes in amounts of force that is sensed by the force sensor 210 for the time period. Additionally, the force sensor 210 may sense magnitude of force that is applied momentarily, and the controller may generate a pattern of changes in force in response to the magnitude of the force.

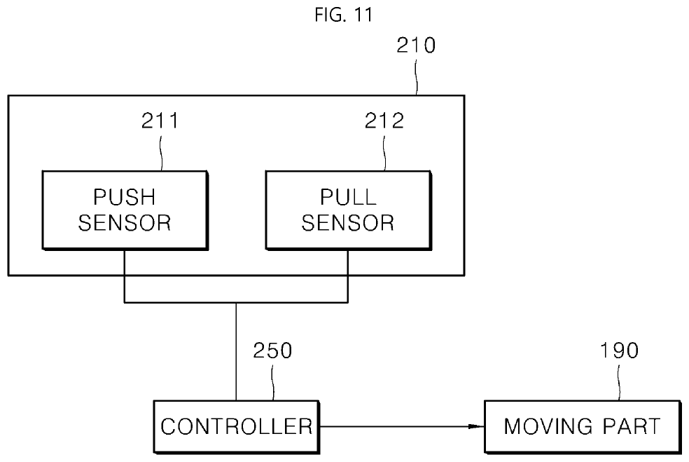

FIG. 11 is a block diagram of elements used by force sensor 210 for adjusting speed of a cart-robot according to an embodiment based on a change in force that is generated after the cart-robot is controlled. In this figure, force sensor 210 includes a push sensor 211 sensing a pushing force and a pull sensor 212 sensing a pulling force. The push sensor 211 senses force that is applied when the user moves the cart-robot forward with respect to a direction where the cart-robot moves forward. The pull sensor 212 senses force that is applied when the user decreases speed of a moving cart-robot, stops the cart-robot, or moves the cart-robot backward with respect to a direction where the cart-robot moves forward.

Accordingly, when the user starts to control a cart-robot, or when the user starts to control a cart-robot again after the user does not control the cart-robot for a certain time period (e.g., 3 min., 5 min., and the like), the controller 250 may customize speed of movement of the cart-robot on the basis of a pattern of changes in force of the user while the user controls the cart.

When the push sensor 211 senses force, the controller 250 generates speed of movement of the cart-robot in response to the sensed force and moves the cart. When there is no sudden change in force or when the pull sensor 212 does not sense force, the controller 250 maintains a mapped relationship between the generated force and speed of movement of the cart. However, when there is a sudden change in force within the shortest time period of movement of the cart-robot, or when the pull sensor 212 senses force, the controller 250 may change the mapped relationship the generated force and speed of movement of the cart.

The shortest time period of movement may be set to, for instance, 10 sec. or 20 sec., one min., and the like, that is a usual time period for which the user changes speed of the cart-robot after starting to control the cart. When speed of the cart-robot is faster than expected after the user starts to push the cart-robot 100, the user pulls the handle assembly 120 to decrease the speed of the cart-robot within the shortest time period of movement. As a result, the pull sensor 212 senses force.

On the contrary, when speed of the cart-robot is slower than expected after the user starts to push the cart-robot 100, the user pushes the handle assembly 120 to increase the speed of the cart-robot within the shortest time period of movement. As a result, the push sensor 211 senses force.

That is, when the user starts to push the cart-robot (after the push sensor senses force) at first, the controller 250 sets variable M1 of equation 1 for mapping speed of movement of the cart-robot_to 1.2 to respond to force of the user.

Additionally, the controller 250 adjusts speed of movement of the moving part, which is mapped in force that is sensed by the push sensor 211 on the basis of the frequency with which the pull sensor 212 senses force within a time period shorter than the shortest time period of movement. For instance, the controller 250 reduces variable M1 of equation 1 for mapping speed of movement of the cart-robot to 1.1 to response to force of the user. As a result of reducing variable M1 of equation 1 to 1.1, speed of movement of the cart-robot is less than force that is sensed by the push sensor 211 than when variable M1 is 1.2 and decreases. This technique may also be applied to increasing speed in the same manner.

When the user starts to push the cart-robot at first (after the push sensor senses force), the push sensor 211 senses first magnitude of force in response to force of the user, and the controller 250 sets variable M1 of equation 1 for mapping speed of moving of the cart-robot to 1.2 to respond to the first magnitude of force.

Next, the controller 250 adjusts speed of movement of the moving part, which is mapped in force that is sensed by the push sensor 211, on the basis of the frequency with which the push sensor 211 senses second the magnitude of force that is greater than the first magnitude of force within a time period shorter than the shortest time period of movement.

For instance, the controller 250 increases variable M1 of equation 1 for mapping speed of movement of the cart-robot_to 1.3, to respond to a second magnitude of changed force of the user. As a result of increasing variable M1 of equation 1 to 1.3, speed of movement of the cart-robot is greater than force that is sensed by the push sensor 211 than when variable M1 is 1.2 and increases.

FIG. 11 shows the controller 250 resetting the mapped relationship between the speed of movement of the cart-robot and force of the user to customize the speed of movement of the cart-robot when speed at which the cart-robot actually moves is different from speed that is expected by the user, with respect to magnitude of force that is applied by the user while the user moves the cart.

The controller 250 in FIG. 11 may collect information that is sensed by an obstacle sensor 220 and may determine whether changes in force of the above push/pull sensors are required for the user to adjust speed of movement of the cart-robot or required for the user to avoid an obstacle. When an obstacle is sensed near the cart-robot 100, the controller 250 does not adjust speed of movement of the cart-robot, which is mapped in force while when an obstacle is not sensed near the cart-robot, the controller 250 may adjust speed of movement of the cart-robot, which is mapped in force.

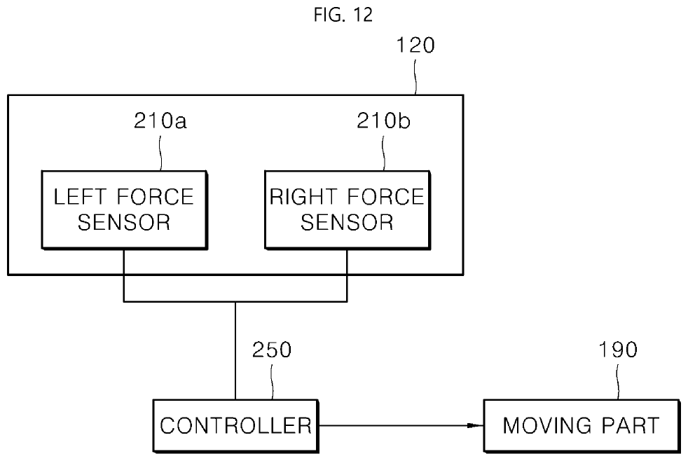

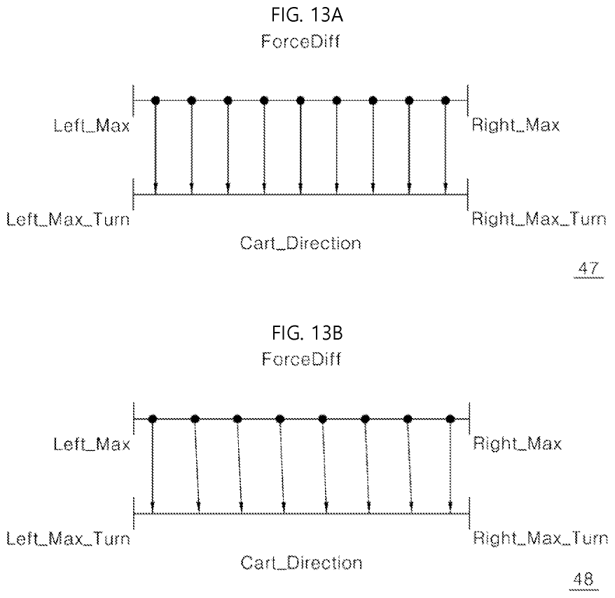

FIGS. 12, 13A, 13B show components and a process of adjusting a direction of a cart-robot according to an embodiment based on a change in force that is generated after the cart-robot is controlled.

In FIG. 12, a force sensor is provided respectively on the right and the left of the handle assembly 120. The left force sensor 210a senses changes in force that is generated from the left hand of the user, which grips the handle assembly 120, while the right force sensor 210b senses changes in force that is generated from the right hand of the user, which grips the handle assembly 120.

The controller 250 calculates a difference in a first magnitude of force that is sensed by the left force sensor 210a and in second magnitude of force that is sensed by the right force sensor 210b and adjusts a direction of movement of the moving part 190.

A direction in response to a difference in forces may be generated as 47 in FIG. 13A. A direction of the cart-robot may be changed to the left or to the right to a maximum degree via maximum value of the left force sensor 210a. A maximum value of the right force sensor 210b including a difference in forces that are sensed by the left force sensor 210a and the right force sensor 210b, and a direction of movement of the cart-robot may be determined based on a difference in forces of both of the force sensors.

Additionally, in the state of 47 that is a basic state, mapping of directions may be adjusted depending on users. While the user adjusts the direction of the cart-robot, the cart-robot may move in a direction that is not matched with a difference in forces applied to both hands by the user. This is because of physical characteristics of the user. Although the user tries to apply the same amount of force to both hands, forces applied to both hands may be different due to physical characteristics of the user. In fact, even though the user applies a different amount of force to both hands of the user, the user may control the cart-robot to move the cart-robot in a straight line.

The controller 250 may adjust a direction of movement of the moving part 190 to a first direction on the basis of the mapped force-direction relationship 47 in FIG. 13A, the left force sensor 210a may sense third magnitude of force within a time period shorter than the shortest time period of movement, and the right force sensor 210b may sense fourth magnitude of force.

In this case, when the controller 250 calculates a difference between the third magnitude of force and the fourth magnitude of force, and, as a result of the calculation, the difference is mapped in a second direction that is opposite or different to the first direction, the controller 250 may reduce the difference in force that is mapped in the first direction of force. For instance, the controller 250 may adjust the mapped force-direction relationship 47 of FIG. 13A to the mapped force-direction relationship 48 in FIG. 13B. Accordingly, although force on the left is greater than that of the right, the extent to which the cart-robot is inclined to the left may be reduced.

The controller 250 confirms patterns of actions of the user (changes in force applied to the handle assembly) and, accordingly, customizes a speed and direction of movement of the cart-robot in embodiments of FIGS. 12, 13A and 13B that show matching the right/left direction with a pattern of changes in force and FIG. 11 that shows matching speed of movement of the cart-robot and a pattern of changes in force.

Additionally, in this process, the controller 250 may confirm whether a new user controls the cart. For instance, the controller 250 may confirm whether the cart-robot is controlled by a new user. When force is not applied to the handle assembly 120 of the cart-robot for a predetermined time period, the controller 250 may confirm the cart-robot would be used by a new user.

Additionally, when objects are loaded in the storage part 110 of the cart-robot and then are unloaded for a predetermined time period, the controller 250 may confirm the cart-robot would be used by a new user.

Further, when the cart-robot 100 is electrically connected to a charging station to be charged, the controller 250 may confirm the cart-robot would be used by a new user.

When the controller 250 confirms that a new user uses the cart-robot on the basis of the above embodiments, the controller restores basic value (information on default settings) of a speed and direction of movement of the cart-robot, which are mapped in a pattern of changes in force.

When the cart-robot 100 is launched, the controller 250 may store information on default setting that maps magnitude of force, sensed by the force sensor 210, as a speed or direction of movement of the cart. Additionally, the controller 250 re-adjusts the pattern of changes in force and the speed/direction of movement of the cart-robot so as to customize the pattern of changes in force and the speed/direction of movement of the cart-robot while the user uses the cart. When the user uses the cart-robot 100 no more, the controller 250 may restore information on default setting such that another user uses the cart-robot 100. Further, the controller 250 may map force itself applied by the user as a speed/direction of movement of the cart-robot on the basis of external factors as well as the user's characteristics or may map the force as a speed/range of directions, which are less than the force.

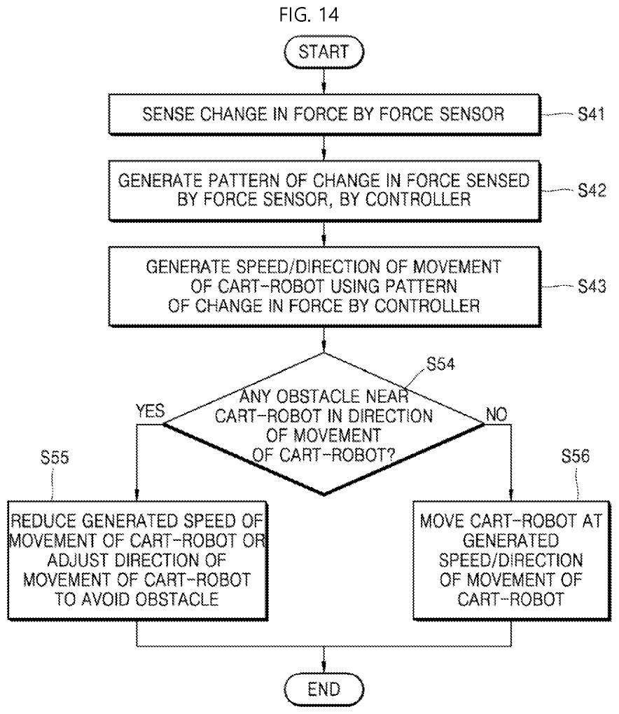

FIG. 14 shows a process of adjusting a speed or a direction of movement of the cart-robot when an obstacle according to an embodiment is sensed. At blocks 41 to 43 of FIG. 14, the controller 250 generates a speed/direction of movement of the cart-robot using a pattern of changes in force (S43). The generation of speed or direction of movement includes calculation or computation of sensed value or stored data. Additionally, the controller 250 confirms whether the obstacle sensor 220 has sensed an obstacle that is placed near the cart-robot in the direction where the cart-robot moves (S54). When confirming that there is an obstacle, the controller 250 reduces the speed of movement of the cart-robot, which is calculated in block 43, or adjusts the direction of movement of the cart-robot, which is calculated in block 43, to avoid the obstacle. When confirming there is no obstacle in block 43, the controller 250 moves the cart-robot using the speed and direction of movement of the cart-robot, which are calculated in block 43 (S56).

An embodiment of block 55 is described as follows. The controller 250 calculates 50 cm/sec of speed of movement of the cart-robot in response to magnitude of force that is sensed by the force sensor 210. Additionally, the controller 250 calculates a direction of an angle of 30 degrees to the left from the direction in which the cart-robot moves straight as a direction of movement of the cart.

However, the obstacle sensor 220 senses that an obstacle is placed in the direction in which the cart-robot moves, that is, the obstacle sensor 220 senses that an obstacle is placed one meter apart from the cart-robot in a direction of an angle of 30 degrees to the left from the direction in which the cart-robot moves. In this case, the controller 250 reduces “50 cm/sec” of speed of movement of the cart-robot, calculated in response to force of the user, to “40 cm/sec” or changes “an angle of 30 degrees to the left” as a direction of movement of the cart-robot, calculated in response to force of the user, to “an angle of 20 degrees to the left”.

The controller 250 adjusts one or two of the speed and direction of movement of the moving part 190, which is mapped in the force sensed by the force sensor 210, to prevent the cart-robot from bumping against the obstacle. If the user pushes or pulls the cart-robot using strong force such that the cart-robot approaches to the obstacle although the controller adjusts the speed or direction of movement of the cart-robot, which is mapped in the force sensed by the force sensor, the controller 250 may stop movement of the cart-robot when the cart-robot approaches to the obstacle.

When the obstacle sensor 220 senses that there are a plurality of obstacles near the cart-robot 100, the controller 250 may be temporality out of power-assist mode. That is, the cart-robot is controlled and moved only by force of the user without electric power. Thus, the user may avoid the obstacle and move the cart. Then when the obstacle sensor 220 senses that there is no obstacle, the controller may be in power-assist mode again and, although the user applies a small amount of force, may increase the speed of movement of the cart-robot, which is mapped in the force.

Further, the controller 250 may sense a tilt of the cart-robot and, when the cart-robot is on the moving walkway, may optionally apply power-assist mode. For instance, when the cart-robot is on the downward moving walkway, the controller 250 may stop power-assist mode in the direction in which the cart-robot moves forward while maintaining power-assist mode in the direction in which the cart-robot moves backward.

When the cart-robot is on the upward moving walkway, the controller 250 may stop power-assist mode in the direction in which the cart-robot moves backward while maintaining power-assist mode in the direction in which the cart-robot moves forward.

The controller 250 may apply power-assist mode that controls the speed and direction of movement of the moving part in response to force of the user on the basis of a gradient (angle) in the space where the cart-robot moves, so as to protect the user and reduce the possibility that the cart-robot bumps against obstacles. Additionally, the controller may adjust the speed of movement of the cart-robot in response to a pattern of changes in force on the basis of an angle of the gradient.

Tables 2 and 3 below show that speed of movement of the cart-robot is adjusted in power-assist mode on the basis of a gradient. The adjusted speed of movement of the cart-robot may be calculated as in table 2 or table 3 and FIGS. 8A, 8B, 10A, 10B. There are various ways of calculating speed of movement of the cart-robot in response to force.

TABLE 2

| | SPEED OF MOVEMENT OF CART-ROBOT IN POWER-ASSIST | | |
|---|---|---|---|
| FORCE | MODE | | |
| APPLIED BY | | FIVE-DEGREE | TEN-DEGREE |
| USER | LEVEL GROUND | UPWARD SLOPE | UPWARD SLOPE |
| 5 | 30 cm/sec | 35 cm/sec | 38 cm/sec |
| 10 | 50 cm/sec | 55 cm/sec | 57 cm/sec |

TABLE 3

| | SPEED OF MOVEMENT OF CART-ROBOT IN POWER-ASSIST | | |
|---|---|---|---|
| | MODE | | |
| FORCE | | FIVE-DEGREE | |
| APPLIED BY | | DOWNWARD | TEN-DEGREE |
| USER | LEVEL GROUND | SLOPE | DOWNWARD SLOPE |
| 5 | 30 cm/sec | 20 cm/sec | 15 cm/sec |
| 10 | 50 cm/sec | 40 cm/sec | 30 cm/sec |

Further, the controller 250 may confirm space where the cart-robot may be in power-assist mode and may get the cart-robot into power-assist mode. As described above, when there is no obstacle near the cart-robot, the car moves in power-assist mode. Furthermore, when the cart-robot is in the parking lot, an empty lot, and the like, the controller 250 controls the cart-robot in power-assist mode.

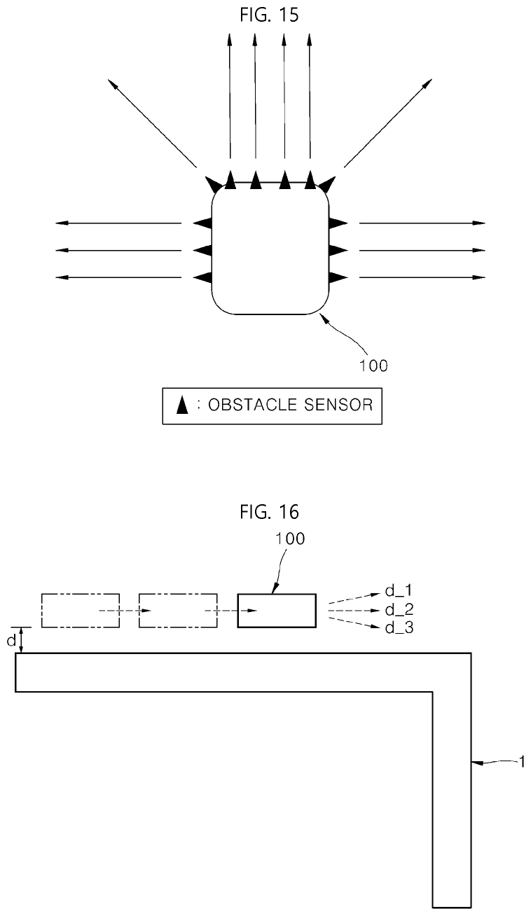

FIG. 15 shows ranges and directions that are sensed by an obstacle sensor provided in a cart-robot according to an embodiment. A plurality of obstacle sensors 220 sense an obstacle in the forward direction of the obstacle, in both lateral directions of the obstacle and the diagonal direction of the obstacle like the full line arrows.

When the obstacle sensor senses that there are a plurality of obstacles, the controller may decrease speed of movement of the cart-robot in response to force applied by the user. Consider the case where the user pushes the cart-robot with magnitude “5” of force as in Table 4. When the obstacle sensor senses that there are a plurality of obstacles, the controller 250 adjusts speed of movement of the cart-robot such that the speed is greater than the speed (10 cm/sec) at which the cart-robot moves when the user itself pushes the cart-robot without electric power but less than the speed (30 cm/sec) at which the cart-robot moves in power-assist mode in usual case as Table 1.

When magnitude 5 of force is sensed as a result of adjusting the speed of movement of the cart-robot, the controller 250 may adjust the speed of movement of the cart-robot to “20 cm/sec” on the basis of sensed obstacles. When no obstacle is sensed and magnitude 5 of force is sensed, the controller 250 may increase the speed of movement of the cart-robot to “30 cm/sec”.

TABLE 4

| | SPEED OF | SPEED OF | SPEED OF MOVEMENT OF |
|---|---|---|---|
| | MOVEMENT OF | MOVEMENT OF | CART-ROBOT IN POWER- |
| FORCE | CART-ROBOT | CART-ROBOT | ASSIST MODE WITH |
| APPLIED | WITHOUT | IN POWER- | PLURALITY OF |
| BY USER | ELECTRICITY | ASSIST MODE | OBSTACLES SENSED |
| 5 | 10 cm/sec | 30 cm/sec | 20 cm/sec |
| 10 | 20 cm/sec | 50 cm/sec | 35 cm/sec |

The obstacle sensor in FIG. 15 allows the cart-robot 100 to follow a specific obstacle and move. For instance, shelves on which products are displayed may be placed in space such as a large-scale retailer. The obstacle sensor 220 of the controller 250 may sense the shelves. The controller 250 adjusts the speed or direction of movement of the cart-robot in response to a pattern of changes in force such that the cart-robot moves near the shelves when the user moves the cart-robot toward the shelves.

FIG. 16 shows a process during which a cart-robot according to an embodiment moves along a fixed obstacle. The cart-robot 100 moves while keeping a distance of “d” from the fixed obstacle 1 as shown in FIG. 16. For instance, the controller 250 adjusts direction of movement of moving part so the cart-robot can move parallel to the fixed obstacle.

The speed and direction of the cart-robot may be determined by control of the user, and the cart-robot 100 moves in power-assist mode. In an embodiment, a shelf on which products are displayed is a fixed obstacle 1. The user may control movement of the cart-robot in d_1 or in d_3 by applying a different amount of force to the right force sensor and the left force sensor. In this case, the controller 250 may set a direction of movement of the cart-robot, which is sensed and calculated by the force sensor, to d_2 different from d_1 or d_3, not in a usual direction.

For instance, the controller 250 may set a direction of movement of the cart-robot differently on the basis of a difference in forces that are sensed by the right force sensor and the left force sensor and whether the cart-robot 100 follows the shelf

TABLE 5

| | CART-ROBOT CERTAIN | CART-ROBOT NEAR SHELF |
|---|---|---|
| LEFT FORCE − | DISTANCE OR MORE APART | OR CART-ROBOT |
| RIGHT FORCE | FROM SHELF | FOLLOWING SHELF |
| −10 | CHANGE IN DIRECTION TO | CENTRAL-STRAIGHT |
| | LEFT, 20 DEGREES | DIRECTION |
| +10 | CHANGE IN DIRECTION TO | CENTRAL-STRAIGHT |
| | RIGHT, 20 DEGREES | DIRECTION |
| −20 | CHANGE IN DIRECTION TO | CHANGE IN DIRECTION TO |
| | LEFT, 30 DEGREES | LEFT, 15 DEGREES |
| +20 | CHANGE IN DIRECTION TO | CHANGE IN DIRECTION TO |
| | RIGHT, 30 DEGREES | RIGHT, 15 DEGREES |
| −30 | CHANGE IN DIRECTION TO | CHANGE IN DIRECTION TO |
| | LEFT, 40 DEGREES | LEFT, 40 DEGREES |
| +30 | CHANGE IN DIRECTION TO | CHANGE IN DIRECTION TO |
| | RIGHT, 40 DEGREES | RIGHT, 40 DEGREES |

When the force sensed by the left force sensor is less than that sensed by the right force sensor (minus value), the controller 250 may change the direction of the cart-robot to the left. Conversely, when the force sensed by the left force sensor is greater than that sensed by the right force sensor (plus value), the controller 250 may change the direction of the cart-robot to the right.

When a difference between the force sensed by the left force sensor and the force sensed by the right force sensor is “−10”, the controller 250 of the cart-robot 100 that is far away from the shelf instructs the moving part 190 to change the direction of the moving part into a direction of an angle of 20 degrees to the left in response to the difference in forces sensed by the left and right force sensors.

Even when a difference between the force sensed by the left force sensor and the force sensed by the right force sensor is “−10”, the controller 250 of the cart-robot 100 that is near the shelf or has followed the shelf so far determines that the difference in forces sensed by the left and right force sensors is not big and instructs the moving part 190 to keep moving straight toward the center. This mechanism is also applied when the difference between the force sensed by the left force sensor and the force sensed by the right force sensor is “+10”.

When a difference between the force sensed by the left force sensor and the force sensed by the right force sensor is “−20”, the controller 250 of the cart-robot 100 that is far away from the shelf instructs the moving part 190 to change the direction of the moving part into a direction of an angle of 30 degrees to the left in response to the difference in forces sensed by the left and right force sensors.

Even when a difference between the force sensed by the left force sensor and the force sensed by the right force sensor is “−20”, the controller 250 of the cart-robot 100 that is near the shelf or has followed the shelf so far reduces a difference between the forces sensed by the left and right force sensors without mapping the difference itself in a change in the direction of the moving part. As a result, the controller instructs the moving part 190 to change the direction of the moving part into a direction of an angle of 15 degrees to the left. This mechanism is also applied when the difference between the force sensed by the left force sensor and the force sensed by the right force sensor is “+20”.

When the user applies a difference of force, that the difference is at certain magnitude or above, to the force sensor, the cart-robot changes its direction on the basis of the user's intention. Table 5 shows a difference between forces sensed by the left and right force sensors is “+30” or “−30”.

When a difference between the force sensed by the left force sensor and the force sensed by the right force sensor is “−30”, the controller 250 changes the direction of the cart-robot to a direction of an angle of 40 degrees to the left regardless of the current position of the cart-robot or whether the cart-robot has followed the shelf When the user adjusts the direction of the cart-robot 100 that is following the shelf, the cart-robot may move straight along the shelf within a certain range of differences between the forces of the left and right, and the controller 250 changes the direction of the cart-robot 100 in response to force applied by the user out of the certain range of differences between the forces of the left and right.

In FIG. 16, when a difference between the left and right forces applied by the user to the cart-robot 100 is a predetermined value (e.g., 10) or less, the controller 250 controls the cart-robot 100 such that the cart-robot moves straight in direction d-2.

In FIG. 16, when a difference between the left and right forces applied by the user to the cart-robot 100 is within a predetermined range of differences (e.g., 11 to 29 or −29 to −11), the controller 250 changes the direction of movement of the cart-robot 100 to direction d_1 or direction d_3 and reduces magnitude of a change in the direction.

In FIG. 16, when a difference between the left and right forces applied by the user to the cart-robot 100 is a predetermined value (e.g., 30) or more, the controller 250 changes the direction of movement of the cart-robot 100 to direction d_1/direction d_2 and sets the direction that is calculated in response to the difference in forces.

That is, in FIG. 16, the controller 250 calculates a difference between force sensed by the left force sensor and force sensed by the right force sensor. Additionally, the controller 250 adjusts the direction of movement of the moving part 190 toward the fixed obstacle in proportion to the calculated difference between the forces and controls the cart-robot such that the cart-robot moves along the fixed obstacle 1 that is placed near the cart-robot 100.

When the controller 250 confirms that a direction is radically changed as a result of calculating a difference between force sensed by the left force sensor and force sensed by the right force sensor, the obstacle sensor 220 senses whether an obstacle is near the cart. When the obstacle sensor senses that an obstacle is near the cart-robot, the controller 250 may reduce magnitude of a change in the direction. Even when the same magnitude of force is sensed by the left and right force sensors as in table 6, the direction of the cart-robot, controlled by the controller 250, may differ on the basis of whether there is an obstacle is near the cart.

TABLE 6

| LEFT FORCE − | WITH NO OBSTACLE | WITH OBSTACLES AROUND |
|---|---|---|
| RIGHT FORCE | AROUND CART | CART |
| −80 | CHANGE IN DIRECTION | CHANGE IN DIRECTION TO |
| | TOLEFT, 120 DEGREES | DIRECTION OF ANGLE OF |
| | | 70 DEGREES TO LEFT AS |
| | | ANGLE WITH CERTAIN GAP |
| | | APART FROM OBSTACLE |
| +80 | CHANGE IN DIRECTION TO | CHANGE IN DIRECTION TO |
| | RIGHT, 120 DEGREES | DIRECTION OF ANGLE OF |
| | | 70 DEGREES TO RIGHT AS |
| | | ANGLE WITH CERTAIN GAP |
| | | APART FROM OBSTACLE |

Even when the same magnitude of force is sensed as in Table 6, a direction of movement of the cart-robot may differ on the basis of whether an obstacle is sensed near the cart. The controller 250 controls the direction of movement of the cart-robot 100 on the basis of a distance between the cart-robot and an obstacle or distribution of obstacles.

In the above embodiments, force applied to the cart-robot by the user is assisted by electric energy to allow the user to easily move the cart. Additionally, the cart-robot may move on the basis of changes in force such as magnitude, a difference, and the like of force that is applied to the handle assembly by the user such that the user controls movement of the cart.

Further, in the embodiments, even when the same magnitude of force is applied, the speed or direction of movement of the cart-robot may differ on the basis of differences in force applied to the cart-robot by different users, obstacles near the cart-robot, positions of the cart-robot, and the like.

In an embodiment, a robot that takes a cart as an example may sense a step width of a user or a speed of movement of a user to change the speed of movement of the robot. Specifically, the obstacle sensor 220 senses a height, or a step width, or speed of movement of a user who closely approaches to or controls the handle assembly of the robot such as a cart, or senses a distance between the user and the cart. Additionally, the controller 250 generates a pattern of a change in force on the basis of a value sensed by the obstacle sensor 220 and controls movement of the cart.

That is, to identify features of a user, the controller 250 of the robot, e.g. a cart, may use at least one of intensity of force that is produced when the user pushes or pulls the cart for the first time, a step width of the user, a walking speed of the user. To this end, in addition to the force sensor, a camera may be placed at the robot to identify a step width of a user or physical features of a user.

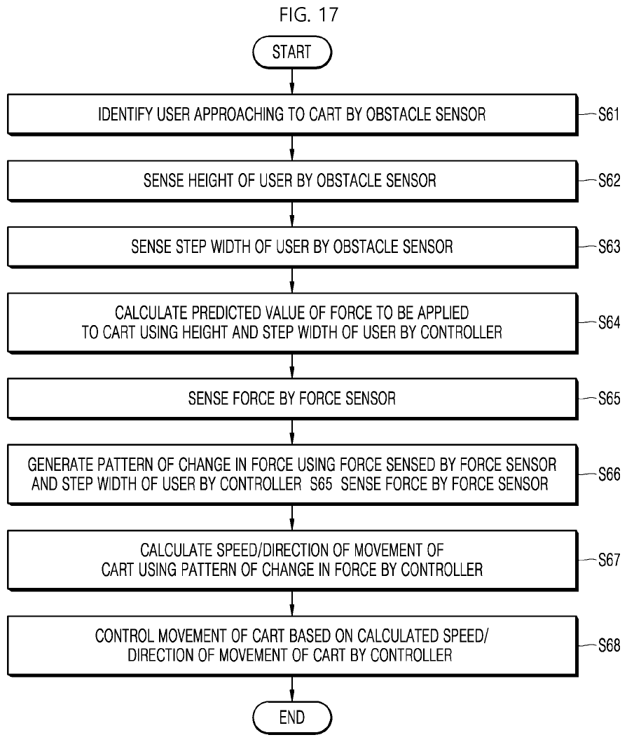

FIG. 17 shows a process of identifying features of a user in an initial phase according to an embodiment. In the process, the obstacle sensor 220 identifies physical features of a user who starts to push the cart.

The obstacle sensor 220 identifies a user who approaches to the cart (S61). In this case, a camera sensor that captures an image of a user is an example of the obstacle sensor 220. Alternately, a camera sensor that captures of an image of the legs of a user is an example of the obstacle sensor 220. Alternately, an infrared sensor that senses the legs of a user or senses a height of a user is an example of the obstacle sensor 220. Alternately, an ultrasonic sensor that senses the legs of a user or senses a height of the user is an example of the obstacle sensor 220. The obstacle sensor 220 may include one or more of the above-described sensors or a plurality of the above-described sensors.

The obstacle sensor 220 senses a height of a user (S62). Additionally, the obstacle sensor 220 senses a step width of the user (S63). Step 62 or step 63 may be performed reversely, or either step 62 or step 63 may be performed, or step 62 and step 63 may be performed at the same time.

The controller 250 calculates a predicted value of force applied to the cart using the height and step width of the user (S64). When the user is tall, or has a wide step width, or when the user has a narrow step width but walks fast, it is highly likely that the user pushes the cart strongly. Accordingly, the controller 250 applies the physical features of the user when the cart is moved. Then the force sensor senses force (S65). Next, the controller 250 calculates a pattern of a change in force using the force sensed by the force sensor and using the predicted value of the force that is previously calculated (S66).

Next, the controller 250 calculates a speed and a direction of movement of the cart using the pattern of a change in force (S67). Then the controller 250 controls movements of the cart on the basis of the calculated speed and direction of movement of the cart (S68).

On the basis of FIG. 17 and description with reference to FIG. 17, the robot that takes a cart as an example may control movements of the robot by applying physical features of a user who pushes the robot.

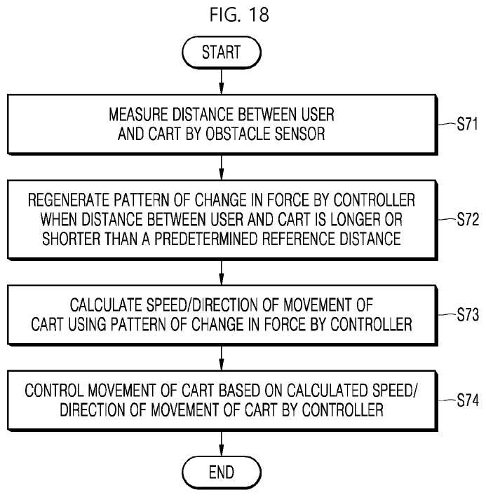

FIG. 18 shows a process of identifying features of a user during movement according to an embodiment.

The obstacle sensor 220 measures a distance between a user and the cart (S71). Monitoring a distance between a user and the cart is presented as an example of a distance measuring method. Measuring a distance between the cart and a user with an ultrasonic sensor, an infrared sensor, a camera sensor and the like are presented as the distance measuring method.

The distance is used to compare a speed of movement of the cart with a speed of movement of the user. If the distance between the user and the cart is longer or shorter than a reference distance, the speed of movement of the cart does not match with the speed of movement of the user. In this case, the cart moves faster than the user, or the user moves faster than the cart. Accordingly, the controller recalculates a pattern of a change in force (S72).

Next, the controller calculates a speed and direction of movement of the cart using the recalculated pattern of a change in force (S73). Then the controller controls movements of the cart on the basis of the calculated speed and direction of movement of the cart (S74).

On the basis of FIG. 18 and description with reference to FIG. 18, the robot that takes a cart as an example may adjust a speed or a direction of movement of the cart by measuring a distance between a user who pushes the robot, and the cart.

In a narrow space, the body of the user may come into close contact with the cart. In this case, the space in which the user and the cart move is crowded with many people and objects.

Accordingly, when the distance between the user and the cart becomes short, the controller 250 reduces the possibility of colliding with an external obstacle by reducing a gap/cycle at which the controller senses surrounding obstacles or by reducing the speed of movement of the cart.

When the distance between the user and the cart does not become short due to an increase in the number of adjacent obstacles, as a result of sensing surrounding obstacles by the obstacle sensor 220, the controller 250 may reduce the speed of movement of the cart. When the user pushes the cart using the same amount of force without checking a state in which obstacles are placed around the cart, the controller 250 may automatically reduce the speed of movement of the cart.

Although in embodiments, all the elements that constitute the embodiments of the present disclosure are described as being coupled to one or as being coupled to one so as to operate, the disclosure is not limited to the embodiments. One or more of all the elements may be optionally coupled to operate within the scope of the present disclosure. Additionally, each of the elements may be implemented as single independent hardware, or some or all of the elements may be optionally combined and implemented as a computer program that includes a program module for performing some or all of the combined functions in single hardware or a plurality of hardware. Codes or segments that constitute the computer program may be readily inferred by one having ordinary skill in the art. The computer program is recorded on computer-readable media and read and executed by a computer to implement the embodiments. Storage media that store computer programs includes storage media magnetic recording media, optical recording media, and semiconductor recording devices. Additionally, the computer program that embodies the embodiments includes a program module that is transmitted in real time through an external device.

The embodiments of the present disclosure have been described. However, the embodiments may be changed and modified in different forms by one having ordinary skill in the art. Thus, it should be understood that the changes and modifications are also included within the scope of the present disclosure.

### DESCRIPTION OF THE SYMBOLS

100: CART 110: STORAGE PART

120: HANDLE ASSEMBLY 150: CONTROL MODULE

190: MOVING PART 210: FORCE SENSOR

220: OBSTACLE SENSOR 250: CONTROLLER

What is claimed is:

1. A robot, comprising:
a cart sized to receive one or more objects;
a moving part coupled to the cart;
a handle assembly coupled to the cart;
a first sensor coupled to the handle assembly and being configured to sense force applied to the handle assembly; and
one or more controllers configured to:
map a magnitude of the force sensed by the first sensor to a speed or to a direction of movement using a pattern of changes in the force that is sensed by the first sensor; and
cause the moving part to move the cart according to the speed or to the direction of movement based upon changes in the force sensed by the first sensor.

2. The robot of claim 1, wherein the first sensor comprises a push sensor that senses a pushing force and a pull sensor that sense a pulling force, wherein the one or more controllers are further configured to:
map the pushing force sensed by the push sensor on a basis of frequency with which the pull sensor senses the pulling force within a time period shorter than a shortest time period of movement of the cart; and
adjust the speed of the moving part based on the mapping of the pushing force.

3. The robot of claim 1, wherein the first sensor comprises a push sensor that senses a pushing force and a pull sensor that sense a pulling force, wherein the one or more controllers are further configured to:
after the push sensor senses a first magnitude of the pushing force, map the pushing force sensed by the push sensor on a basis of frequency with which the push sensor senses a second magnitude of force greater than the first magnitude of force within a time period shorter than a shortest time period of movement of the cart; and
adjust the speed of the moving part based on the mapping of the pushing force.

4. The robot of claim 1, further comprising:
a second sensor coupled to the handle assembly, wherein the first sensor is located at left side of the handle assembly and the second sensor is located at a right side of the handle assembly, wherein the one or more controllers are further configured to:
calculate a first difference between a first magnitude of force that is sensed by the left sensor and a second magnitude of force that is sensed by the right sensor; and
adjust the direction of movement based on the calculated first difference.

5. The robot of claim 4, wherein after the adjust the direction to a first direction, the left sensor senses a third magnitude of force within a time period shorter than a shortest time period of movement of the cart, and the right sensor senses a fourth magnitude of force, and wherein the one or more controllers are further configured to:
calculate a second difference between the third magnitude of force and the fourth magnitude of force;
map the second difference as a second direction; and
reduce the first difference based on the second direction being opposite or different relative to the first direction.

6. The robot of claim 4, further comprising:
an obstacle sensor configured to sense an obstacle located relative to the robot, wherein the one or more controllers are further configured to:
calculate a difference between force sensed by the left sensor and force sensed by the right sensor;
adjust the direction of movement of the moving part toward the obstacle in proportion to the calculated difference between the force sensed by the left sensor and the force sensed by the right sensor; and
cause the moving part to move the cart in a direction along a side of the obstacle.

7. The robot of claim 1, further comprising:
an obstacle sensor configured to sense an obstacle located relative to the robot, wherein the one or more controllers are further configured to:
adjust the speed or the direction of movement of the moving part, based upon the obstacle sensor sensing the obstacle that is located in a path of the direction of movement.

8. The robot of claim 1, further comprising:
a memory, wherein the one or more controllers are further configured to:
store information on default settings used for the map the magnitude of the force that is sensed by the first sensor; and
restore default settings based on the stored information based on the robot being used by a new user.

9. The robot of claim 1, wherein the one or more controllers are further configured to:
adjust the speed based on a degree of gradient of the ground on which the robot is located, or
adjust the direction of movement to be substantially parallel to a fixed object.

10. The robot of claim 1, wherein the robot further comprises an third sensor configured to sense obstacles placed near the robot,
the third sensor senses a height, or a step width, or a speed of movement of a user who closely approaches to or controls the handle assembly of the robot, or senses a distance between the user and the robot, and
the controller calculates a pattern of a change in force on the basis of the sensed value and controls movement of the robot.

11. A method for operating a robot having a cart, the robot comprising:
causing the cart to move using a moving part coupled to the cart;
sense force applied to a handle assembly of the cart using a first sensor; and
mapping a magnitude of the force sensed by the first sensor to a speed or to a direction of movement using a pattern of changes in the force that is sensed by the first sensor; and
moving the cart according to the speed or to the direction of movement based upon changes in the force sensed by the first sensor.

12. The method of claim 11, wherein the first sensor comprises a push sensor that senses a pushing force and a pull sensor that sense a pulling force, wherein the method further comprises:
mapping the pushing force sensed by the push sensor on a basis of frequency with which the pull sensor senses the pulling force within a time period shorter than a shortest time period of movement of the cart; and
adjusting the speed of the moving part based on the mapping of the pushing force.

13. The method of claim 11, wherein the first sensor comprises a push sensor that senses a pushing force and a pull sensor that sense a pulling force, wherein the method further comprises:
after the push sensor senses a first magnitude of the pushing force, mapping the pushing force sensed by the push sensor on a basis of frequency with which the push sensor senses a second magnitude of force greater than the first magnitude of force within a time period shorter than a shortest time period of movement of the cart; and
adjusting the speed of the moving part based on the mapping of the pushing force.

14. The method of claim 11, wherein the cart further includes a second sensor coupled to the handle assembly, wherein the first sensor is located at left side of the handle assembly and the second sensor is located at a right side of the handle assembly, wherein the method further comprises:
calculating a first difference between a first magnitude of force that is sensed by the left sensor and a second magnitude of force that is sensed by the right sensor; and
adjusting the direction of movement based on the calculated first difference.

15. The method of claim 14, wherein the method further comprises:
after the adjusting the direction to a first direction, sensing by the left sensor a third magnitude of force within a time period shorter than a shortest time period of movement of the cart, and sensing by the right sensor a fourth magnitude of force;
calculating a second difference between the third magnitude of force and the fourth magnitude of force;
mapping the second difference as a second direction; and
reducing the first difference based on the second direction being opposite or different relative to the first direction.

16. The method of claim 14, wherein the cart further includes an obstacle sensor configured to sense an obstacle located relative to the robot, wherein the method further comprises:
calculating a difference between force sensed by the left sensor and force sensed by the right sensor;
adjusting the direction of movement of the moving part toward the obstacle in proportion to the calculated difference between the force sensed by the left sensor and the force sensed by the right sensor; and
moving the moving part to move the cart in a direction along a side of the obstacle.

17. The method of claim 11, wherein the cart further includes an obstacle sensor configured to sense an obstacle located relative to the robot, wherein the method further comprises:
adjusting the speed or the direction of movement of the moving part, based upon the obstacle sensor sensing the obstacle that is located in a path of the direction of movement.

18. The method of claim 11, further comprising:
storing information on default settings used for the mapping the magnitude of the force that is sensed by the first sensor in a memory; and
restoring default settings based on the stored information based on the robot being used by a new user.

19. The method of claim 11, wherein the method further comprises:
adjusting the speed based on a degree of gradient of the ground on which the robot is located, or
adjusting the direction of movement to be substantially parallel to a fixed object.

20. The method of claim 11, further comprising:
sensing a height, or a step width, or a speed of movement of a user who closely approaches to or controls a handle assembly of the robot, or sensing a distance between the user and the robot, by the obstacle sensor, and
calculating a pattern of a change in force on the basis of the sensed value and controlling movement of the robot, by the controller.
